(19) United States
(12) Patent Application Publication
(10) Pub. No.: US 2007/0081837 A1
(43) Pub. Date: Apr. 12, 2007

(54) IMAGE FORMING APPARATUS HAVING PRESSING ROLLER APPARATUS

(76) Inventor: Seung-jun LEE, Suwon-si (KR)

Correspondence Address: STANZIONE & KIM, LLP, 919 18TH STREET, N.W., SUITE 440, WASHINGTON, DC, 20006, US

(21) Appl. No.: 11/536,168

(22) Filed: Sep. 28, 2006

(30) Foreign Application Priority Data
Oct. 6, 2005 (KR) 2005-93890

(51) Int. Cl. G03G 15/20

(52) U.S. Cl. 399/328; 399/333

(57) ABSTRACT

An image forming apparatus includes a heating roller to apply heat to a printing medium, a hollow pressing roller to rotate in an opposite direction with respect to the heating roller with the printing paper located therebetween, and to press the printing paper, and a supporting member disposed in the pressing roller to radially support the pressing roller.

### CROSS-REFERENCE TO RELATED APPLICATIONS

This application claims the priority of Korean Patent Application No. P2005-0093890, filed on Oct. 06, 2005, in the Korean Intellectual Property Office, the disclosure of which is incorporated herein by reference.

### BACKGROUND OF THE INVENTION

1. Field of the Invention

The present general inventive concept relates to an image forming apparatus, and more particularly, to an image forming apparatus and a pressing roller apparatus therefor which is capable of enhancing a heating efficiency of a heating roller.

2. Description of the Related Art

Generally, an image forming apparatus visualizes image information which is processed by an image processing apparatus, such as a host computer, by printing the image information on a printing paper. The image forming apparatus is classified as an electrophotographic type where an image is formed by applying a developer to an electrostatic latent image formed on a photosensitive element using a potential difference and then transferring the developed image to a sheet of printing paper, an inkjet type where an image is formed by discharging ink onto the printing paper through a plurality of inkjet nozzles, a thermal transfer type where an image is formed by selectively heating an ink ribbon in contact with a printing paper, etc. The electrophotographic type of an image forming apparatus is widely adopted because of its high printing speed, high resolution and low cost.

Such an image forming apparatus comprises a paper feeding part, an LSU (light scanning unit), a developing part, a fixing part, and a discharging part. The paper feeding part supplies a sheet of printing paper to the developing part and the LSU scans a light, and then the developing part selectively applies a developer onto the printing paper to form a printed image. The fixing part fixes the applied developer on the printing paper by applying heat and pressure. The discharging part receives the printing paper having the fixed developer from the developing part and discharges the printing paper to an outside thereof. The developing part comprises a photosensitive element, a developing roller, and a fixing roller. If the LSU scans light onto the photosensitive element to form an electrostatic latent image, the developing roller develops the electrostatic latent image by supplying the developer to the electrostatic latent image, and the fixing roller transfers the developed image formed on the photosensitive element to the printing paper.

The fixing part comprises a heating roller and a pressing roller which rotate in opposite directions to each other with respect to the printing paper located therebetween. The heating roller applies heat to the printing paper and the pressing roller applies pressure to the printing paper. The developer applied to the printing paper by the developing part is fused and fixed onto the printing paper by the heat from the heating roller and the pressure from the pressing roller.

FIG. 1 is an exploded perspective view illustrating a conventional roller 101 of a conventional image forming apparatus. Referring to FIG. 1, the conventional roller 101 of the image forming apparatus comprises a heating roller (not shown) and a pressing roller 120. The heating roller applies heat to a sheet of printing paper and the pressing roller 120 applies pressure to the printing paper, so that the developer can be fixed onto the printing paper.

The hollow pressing roller 120 rotates in an opposite direction to the heating roller (not shown) with respect to the printing paper located therebetween. Rotating shafts 130 are disposed at opposite end parts of the pressing roller 120 and receive a rotational force from a driving part (not shown) to rotate the pressing roller 120. An elastic layer 122 surrounds a hollow body of the pressing roller 120 and is made of rubber or other elastic material. The elastic layer 122 facilitates the pressing roller 120 to be contacted to and press the printing paper. A pressing spring (not shown) presses the pressing roller 120 toward the heating roller, so that the pressing roller 120 can press the printing paper.

According to the conventional roller 101 of the conventional image forming apparatus, as a considerable part of the heat which has been applied to the printing paper by the heating roller is absorbed by the pressing roller 120, a heating efficiency of the heating roller may be lowered. To minimize an amount of the heat absorbed by the pressing roller 120, a heat capacity of the pressing roller 120 needs to be minimized.

However, the pressing roller 120 must have a roller surface with a predetermined thickness in order that the pressing roller 120 may not be deformed by the pressure applied by the pressing spring and the heat applied by the heating roller. The thickness of the pressing roller 120 affects an increased volume and an increased heat capacity of the pressing roller 120. Consequently, as the heat loss of the heating roller occurs because of the heat absorption of the pressing roller 120, the heating efficiency may be lowered, for example, a period of time required to heat the heating roller may be extended.

### SUMMARY OF THE INVENTION

Accordingly, it is an aspect of the present general inventive concept to provide an image forming apparatus and a pressing roller apparatus therefor which is capable of enhancing a heating efficiency of a heating roller thereof.

Additional aspects and/or advantages of the present general inventive concept will be set forth in part in the description which follows and, in part, will be obvious from the description, or may be learned by practice of the present general inventive concept.

The foregoing and/or other aspects of the present general inventive concept may be achieved by providing an image forming apparatus comprising a heating roller to apply heat to a sheet of printing paper, a hollow pressing roller to rotate in an opposite direction to the heating roller with respect to the printing paper located therebetween, and to press the printing paper, and a supporting member disposed in the pressing roller to radially support the pressing roller.

The supporting member may comprise a plurality of supporting rims disposed apart from each other along an axis of the pressing roller, and a plurality of supporting ribs being connected to the supporting rims to contact an inner surface of the pressing roller.

The supporting ribs may be disposed at opposite end parts of the pressing roller.

The supporting ribs may be disposed apart from each other with a predetermined angle therebetween at each supporting rim and spirally extend in an axial direction of the pressing roller.

The image forming apparatus further may comprise a rotating shaft provided at one end part of the pressing roller and a driving part driving the rotating shaft to rotate in a first rotating direction, wherein the supporting ribs spirally extend to be opposite to the first rotating direction.

The supporting ribs may be disposed apart from each other with a predetermined angle therebetween at each supporting rim and extend in an axial direction of the pressing roller.

The supporting ribs may form mesh structures.

The pressing roller may have a thickness gradually decreasing from its center part to its end part.

The foregoing and/or other utilities of the present general inventive concept may also be achieved by providing a pressing roller apparatus comprising a hollow pressing roller to press a sheet of printing paper, and a supporting member disposed in the pressing roller to radially support the pressing roller.

The foregoing and/or other utilities of the present general inventive concept may also be achieved by providing a roller unit usable with an image forming apparatus, the roller unit including a heating roller to generate heat, and a pressing roller to rotate with respect to the heating roller, and having a hollow body, an elastic element formed on an outer circumferential surface of the hollow body, and a supporting member formed on an inside circumferential surface of the hollow body to support the hollow body.

The foregoing and/or other utilities of the present general inventive concept may also be achieved by providing an image forming apparatus, including a printing unit to form an image on a printing medium, a roller unit to fix the image to the printing medium and having a heating roller to generate heat, and a pressing roller to rotate with respect to the heating roller, the pressing roller having a hollow body, an elastic element formed on an outer circumferential surface of the hollow body, and a supporting member formed on an inside circumferential surface of the pressing roller to support the hollow body.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is an exploded perspective view illustrating a conventional image forming apparatus;

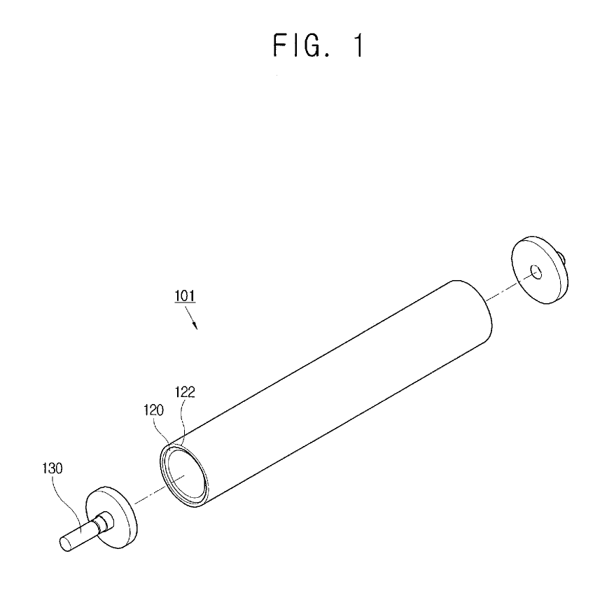

FIG. 2 is a schematic view illustrating a roller unit usable with an image forming apparatus according to an embodiment of the present general inventive concept;

FIG. 3 is a section view illustrating the roller unit of the image forming apparatus of FIG. 2 at a line III-III of FIG. 2;

FIG. 4 is a cross section view illustrating the roller of the image forming apparatus of FIG. 2 at a line IV-IV of FIG. 2;

FIG. 5 is a perspective view illustrating a supporting member of the image forming apparatus of FIG. 2;

FIG. 6 is a perspective view illustrating a roller unit usable with an image forming apparatus according to and embodiment of the present general inventive concept;

FIG. 7 is a perspective view illustrating a roller unit usable with an image forming apparatus according to an embodiment of the present general inventive concept;

FIG. 8 is a schematic view illustrating a roller unit usable with an image forming apparatus according to an embodiment of the present general inventive concept; and

FIG. 9 is a view illustrating an image forming apparatus having the roller unit of FIGS. 2-8.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

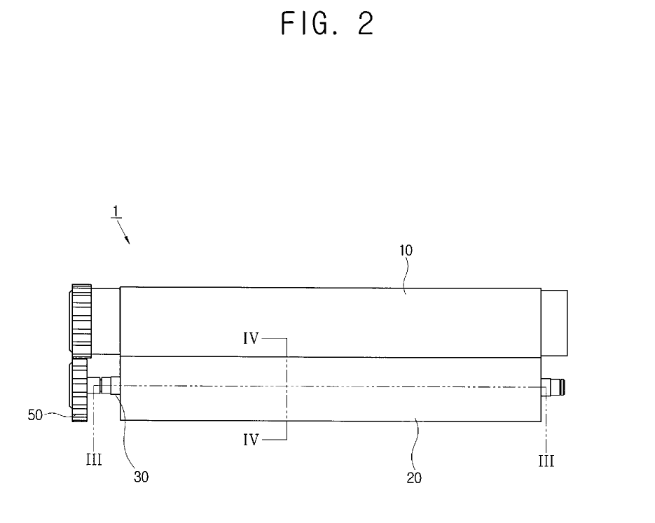

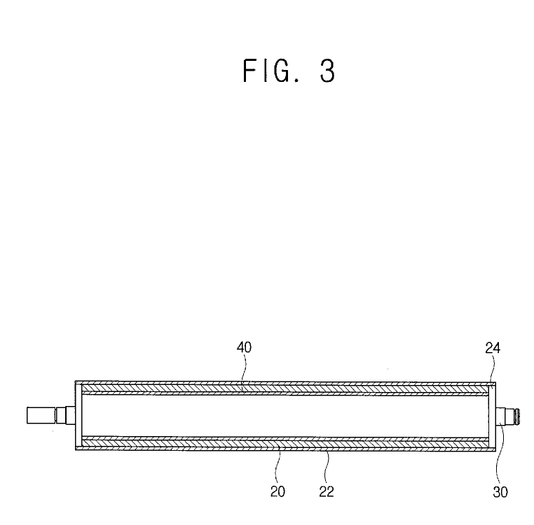

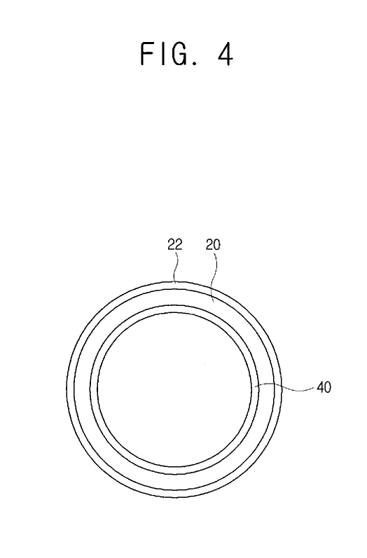

As illustrated in FIGS. 2 to 5, a roller unit 1 usable with an image forming apparatus comprises a heating roller 10 to apply heat to a printing medium, such as a sheet of printing paper, a hollow pressing roller 20 to rotate in an opposite direction to the heating roller 10 with respect to the printing paper located therebetween to press the printing paper and a supporting member 40 disposed in the pressing roller 20 to radially support the pressing roller 20 with respect to a rotation axis thereof.

The heating roller 10 and the pressing roller 20 are supported by a frame (not shown) so that the printing paper may pass between the heating roller 10 and the pressing roller 20. The heating roller 10 may have a cylinder shape. A heater (not shown) is disposed in the heating roller 10 to heat a roller surface of the heating roller 10 to a predetermined temperature so that the heating roller 10 can apply the heat to the printing paper.

The pressing roller 20 is pressed toward the heating roller 10 by a pressing member (not shown). The pressing member may be provided as a coil spring, a plate spring, or an elastic element. The pressing roller 20 has a hollow body having a shape of a hollow cylinder with a predetermined thickness. An outer surface of the pressing roller 20 is surrounded by an elastic element 22. The elastic element 22 may be made of rubber, plastic or other elastic material. The elastic member 22 expands a nip with a surface of the printing paper which is in contact with and pressed by the pressing roller 20 and the heating roller 10, so that the pressing roller 20 can effectively press the printing paper against the heating roller 10.

Opposite end sides of the pressing roller 20 are closed by side plates 24. Therefore, a hollow center part of the pressing roller 20 is shut off from an outside thereof. Also, the opposite end sides of the pressing roller 20 are provided with a rotating shaft 30 which rotates together with the pressing roller 20. A driving part 50 drives the rotating shaft 30 to rotate in a first rotating direction, so that the pressing roller 20 can transfer and press the printing paper. Also, the driving part 50 may drive the heating roller 10 to rotate so that the heating roller 10 may cooperate with the pressing roller 20.

The supporting member 40 is disposed in the pressing roller 20 to contact an inner surface of the pressing roller 20. The supporting member 40 radially supports the pressing roller 20 to increase a strength of the pressing roller 20 in a direction perpendicular to a roller surface of the pressing roller 20. The supporting member 40 prevents the pressing roller 20 from being bent or deformed due to a pressure by the pressing member (not shown) and the heat by the heating roller 10. Also, the supporting member 40 can minimize a thickness of a roller surface of the pressing roller 20. Accordingly, the supporting member 40 decreases a heat capacity of the pressing roller 20, and thus an amount of the heat transferred from the heating roller 10 and absorbed by the pressing roller 20 may be minimized. Using the supporting member 40 reduces a time required to heat the heating roller 10 and enhances a heating efficiency of the heating roller 10.

The supporting member 40 may be made of a material with a superior strength, or the supporting member 40 can be made of plastic or other material having a low heat conductivity. The supporting member 40 may be made of a metal or other material having a heat conductivity.

The supporting member 40 comprises a plurality of supporting rims 42 disposed apart from each other along a longitudinal axis of the pressing roller 20 to contact an inner circumferential surface of the pressing roller 20, and a plurality of supporting ribs 44 being in contact with the supporting rims 42 and the inner surface of the pressing roller 20. The supporting rims 42 and the supporting ribs 44 radially support the pressing roller 20 in cooperation to prevent the bending deformation, fatigue deformation, etc., in the pressing roller 20.

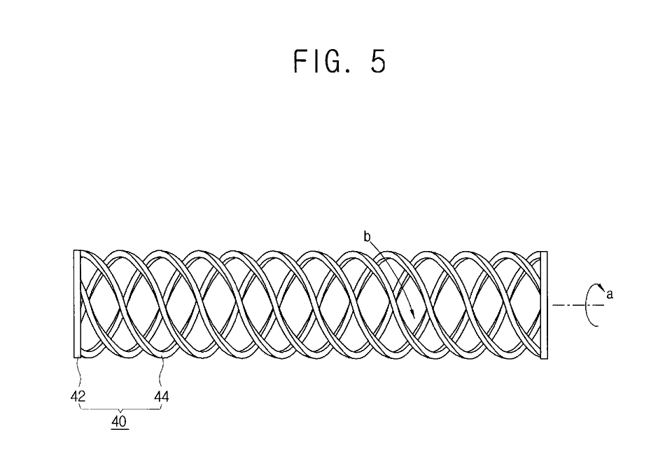

Each supporting rim 42 has a ring shape so that they can contact the inner surface of the pressing roller 20 along a circumference of opposite end parts of the pressing roller 20. Although FIGS. 5 illustrates the supporting rims 42 disposed at opposite end parts of the pressing roller 20, the supporting rims 42 may also be disposed at other position along a direction of the longitudinal axis of the pressing roller 20 than the opposite end parts. Also, the supporting rims 42 may be provided as three or more at a predetermined interval therebetween.

The supporting ribs 44 are disposed apart from each other by the predetermined interval, have an angle with each supporting rim 42, and spirally extend from the supporting rims 42 in an axial direction of the pressing roller 20. The supporting ribs 44 contact the inner surface of the pressing roller 20 and radially support the pressing roller 20. The supporting ribs 44 are disposed apart from each other with the same angle with respect to each supporting rim 42. The respective supporting ribs 44 are spaced apart from each other by a distance in the longitudinal direction of the pressing roller 20 while winding around the inside surface of the pressing roller 20 in the longitudinal direction of the pressing roller 20.

The supporting ribs 44 spirally extend in a second rotating direction “b” from one of the opposite end parts to the other one of the opposite end parts in FIG. 5 which is opposite to a first rotating direction “a” in which the driving part 50 drives the rotating shaft 30 to rotate. Accordingly, the supporting ribs 44 can increase the strength of the pressing roller 20 against torsional deformation in the first rotating direction a. That is, the supporting ribs 44 can minimize the torsional deformation of the pressing roller 20 in the first rotating direction “a” when the driving part 50 drives the rotating shaft 30 to rotate in the first rotating direction “a.”

Alternatively, the supporting ribs 44 may spirally extend in the first rotating direction “a.” Also, at least one of the supporting ribs 44 may spirally extend in the first rotating direction “a” and the other supporting ribs 44 may spirally extend in the second rotating direction “b.”

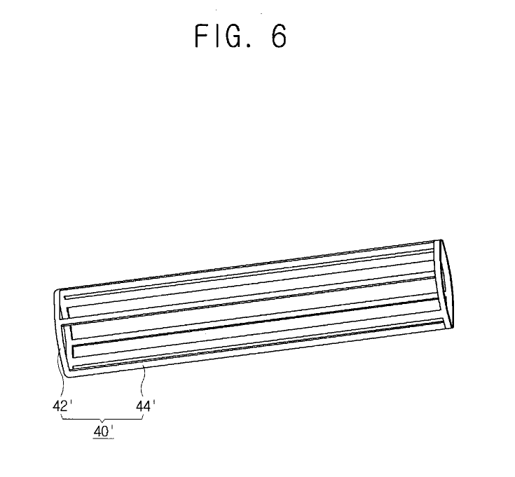

Hereinafter, a roller unit usable with an image forming apparatus according to an embodiment of the present general inventive concept will be described referring to FIG. 6.

As illustrated in FIG. 6, a supporting member 40′ comprises supporting rims 42′ and supporting ribs 44′. The supporting ribs 44′ are disposed apart from each other with a predetermined angle therebetween in a circumferential direction of a rotation axis (or an axial direction) of the roller unit at each supporting rim 42′ and extend in the axial direction of the pressing roller 20. It is possible that the supporting ribs 44′ are disposed apart from each other to form the same angle with each supporting rim 42′.

The supporting ribs 44′ contact the inner surface of the pressing roller 20 and are parallel with each other to the rotation axis of the pressing roller 20, and thus the supporting ribs 44′ can uniformly support the pressing roller 20 around a circumference thereof.

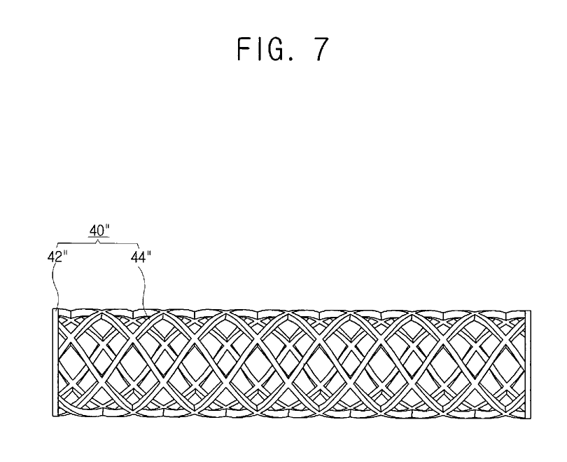

Hereinafter, a roller unit usable with an image forming apparatus according to an embodiment of the present general inventive concept will be described referring to FIG. 7.

As illustrated in FIG. 7, a supporting member 40″ comprises supporting rims 42″ and supporting ribs 44″. The supporting ribs 44″ form a mesh structure to connect the supporting rims 42″. The mesh structure of the supporting ribs 44″ may have a shape of polygons such as tetragons or triangles, ovals, etc. Accordingly, a force of the supporting ribs 44″ to support the pressing roller 20 can be maximized, and thus a thickness of the roller surface of the pressing roller 20 can be minimized.

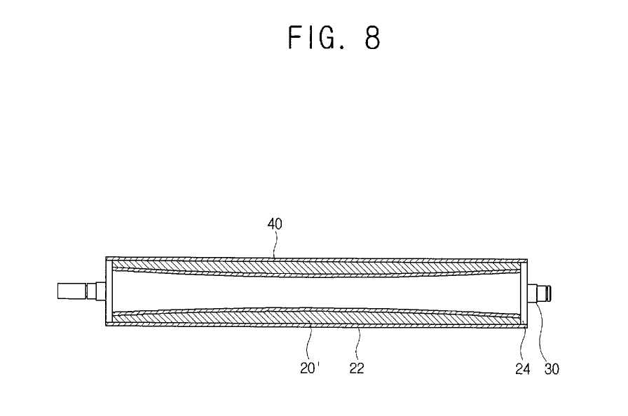

Hereinafter, a roller unit usable with an image forming apparatus according to an embodiment of the present general inventive concept will be described referring to FIG. 8.

As illustrated in FIG. 8, the pressing roller 20′ has a thickness gradually decreasing from its center part to its end part along a rotation axis of the pressing roller 20′. The pressing roller 20′ has such a shape that a thickness of its end part is less than that of its center part.

Accordingly, a strength of its center part can prevent the torsional deformation of the pressing roller 20′ while a thickness of its end part which is relatively strong to its torsional deformation can be reduced, and thus a heat capacity of the pressing roller 20′ can be decreased.

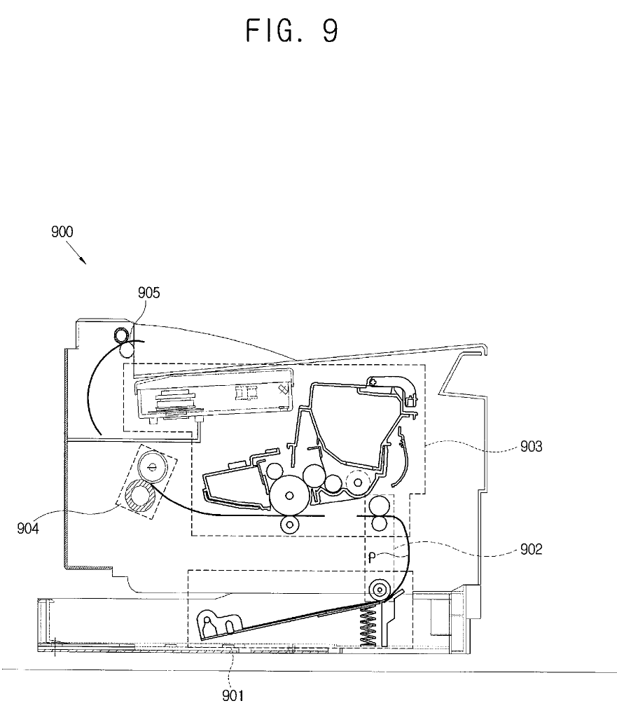

FIG. 9 is a view illustrating an image forming apparatus 900 having the roller unit of FIGS. 2 to 8. Referring to FIG. 9, the image forming apparatus 900 includes a paper cassette 901, a feeding unit 902 to pick up a sheet of paper P from the paper cassette 901, a image forming unit 903 to form an image on the paper P, a roller unit 904 to fix the image on the paper P. and a discharge unit 905 to discharge the paper P with the fixed image. The roller units of FIGS. 2 through 8 can be used as the roller unit 904 as a fixing unit to fix the image on the paper P using heat and pressure as illustrated in FIGS. 2 through 8. Thus, detailed descriptions of the roller unit 904 will be omitted.

As seen from the above descriptions, the thickness of the pressing roller can be minimized and thus the heat capacity of the pressing roller can be decreased by using the image forming apparatus and the pressing roller apparatus therefor according to the present invention where the pressing roller is radially supported by the supporting member.

Therefore, the heat capacity of the pressing roller to absorb the heat of the heating roller can be minimized, which means that the time required to heat the heating roller can be reduced and the heating efficiency of the heating roller can be enhanced.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming apparatus comprising:
a heating roller to apply heat to a printing medium;
a hollow pressing roller to press the printing medium toward the heating roller; and
a supporting member disposed in the pressing roller to radially support the pressing roller.

2. The image forming apparatus according to claim 1, wherein the supporting member comprises a plurality of supporting rims disposed apart from each other along an axis of the pressing roller, and a plurality of supporting ribs being connected to the supporting rims to contact an inner surface of the pressing roller.

3. The image forming apparatus according to claim 2, wherein the supporting ribs are disposed at opposite end parts of the pressing roller.

4. The image forming apparatus according to claim 3, wherein the supporting ribs are disposed apart from each other with a predetermined angle at each supporting rim and spirally extend in an axial direction of the pressing roller.

5. The image forming apparatus according to claim 4, further comprising:
a rotating shaft provided at one end part of the pressing roller: and
a driving part to drive the rotating shaft to rotate in a first rotating direction, wherein the
supporting ribs spirally extend in a direction opposite to the first rotating direction.

6. The image forming apparatus according to claim 3, wherein the supporting ribs are disposed apart from each other with a predetermined angle at each supporting rim and extend in an axial direction of the pressing roller.

7. The image forming apparatus according to claim 3, wherein the supporting ribs form a mesh structure.

8. The image forming apparatus according to claim 1, wherein the pressing roller has a thickness gradually decreasing from its center part to its end part along a rotation axis of the pressing roller.

9. A pressing roller apparatus usable with an image forming apparatus, comprising:
a hollow pressing roller to press a printing medium toward an external roller; and
a supporting member disposed in the pressing roller to radially support the pressing roller.

10. A roller unit usable with an image forming apparatus, comprising:
a heating roller to generate heat; and
a pressing roller to rotate with respect to the heating roller, and having a hollow body, an elastic element formed on an outer circumferential surface of the hollow body, and a supporting member formed on an inside circumferential surface of the hollow body to support the hollow body.

11. The roller unit according to claim 10, wherein the supporting member comprises a plurality of supporting rims mounted to ends of the hollow body, and one or more supporting ribs spaced-apart from each other, formed between the supporting rims, and formed on the inside circumferential surface of the hollow body.

12. The roller unit according to claim 11, wherein the supporting rims and the one or more supporting ribs are formed in a single monolithic body.

13. The roller unit according to claim 11, wherein the one or more supporting ribs are formed between ends of the hollow body in a spiral direction with respect to a rotational axis of the hollow body.

14. The roller unit according to claim 11, wherein the one or more supporting ribs wind around the inside circumferential surface of the hollow body in a direction from one end of the hollow body to the other end of the hollow body.

15. The roller unit according to claim 10, wherein the supporting member winds around the inside circumferential surface of the hollow body in a direction having an angle with a rotational axis of the hollow body.

16. The roller unit according to claim 10, wherein the supporting member comprises one or more ribs having one or more holes formed between adjacent ribs.

17. The roller unit according to claim 10, wherein the supporting member comprises a center portion having a center thickness, and end portions having an end thickness thinner than the center thickness.

18. The roller unit according to claim 10, wherein the supporting member has a thickness varying according to a distance from a center of the hollow body.

19. The roller unit according to claim 10, wherein the pressing roller has a thickness varying between ends thereof.

20. An image forming apparatus, comprising:
a printing unit to form an image on a printing medium;
a roller unit to fix the image to the printing medium, and comprising:
a heating roller to generate heat, and
a pressing roller to rotate with respect to the heating roller, and having a hollow body, an elastic element formed on an outer circumferential surface of the hollow body, and a supporting member formed on an inside circumferential surface of the pressing roller to support the hollow body.
